(19) United States
(12) Patent Application Publication
(10) Pub. No.: US 2003/0036950 A1
(43) Pub. Date: Feb. 20, 2003

(54) Discount purchase business method

(76) Inventor: Martin Khang Nguyen, Westminster, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/931,677

(22) Filed: Aug. 15, 2001

(51) Int. Cl. G06F 17/60

(52) U.S. Cl. 705/14; 705/1

(57) ABSTRACT

A commercial business method provides for establishing a relationship between a manager and plural consumers, manufacturers and retailers. The manager produces universal coupon wallet cards which are used instead of physical coupons but with the same effect as physical coupons of the type that may be received in the mails or cut from newspapers or magazines, etc. When a consumer, having one of the wallet cards sees a coupon which a special indicia printed on it identifying the coupon as able to be used without the actual presence of the coupon itself, the consumer is able to take note of the retailer, product and price and may then purchase the product as if using the physical coupon, by merely presenting the wallet card. The wallet card is scanned by the retailer so as to be able to forward information about the purchase is the corresponding manufacturer either directly or through the manager so as to establish a rebate to the retailer or to the consumer.

### BACKGROUND OF THE INVENTION

1. Field of the Invention

This invention relates generally to discounting methods in the commercial marketplace and more particularly to a discounting business method using a universal coupon card.

2. Description of Related Art

The following art defines the present state of this field:

Valencia et al., U.S. Pat. No. 5,380,991 describes a system and method of allowing a shopper to obtain the benefit of reduced prices for certain items without the necessity of redeeming paper coupons. The system employs an integrated circuit (IC) smart card containing an erasable memory therein. This memory would contain information relating to a discount coupon amount, as well as information relating to particular products which have been purchased. This card would be inserted into a reader/writer terminal provided at a retailer's checkout counter. Items which are purchased are scanned and compared with items to be discounted as well as the information provided by the customer IC smart card. After the cashier has totaled the customer's purchases, the information contained in the IC smart card would be altered accordingly.

Powell, U.S. Pat. No. 5,727,153 describes a system for creating, dispensing, and redeeming electronic discount coupons in a store The system includes a “smart card”, product stations adjacent to selected products in the store, and a checkout station in the checkout area. To create an electronic coupon, the customer inserts the card into the product station adjacent to an product the customer wishes to purchase, and the product station then writes an electronic coupon onto the card. The customer thus shops throughout the store collecting electronic coupons for products of interest. Upon completion of shopping, the customer redeems the electronic coupons at the checkout area, by inserting the card into the checkout station. During checkout, when UPC data matches data stored on the card, the customer is credited with the value of the corresponding coupon. Periodically, the electronic coupon data is transferred to a remote clearing house.

Stich, et al., U.S. Pat. No. 5,760,381 describes debit cards, such as long distance telephone cards, being attractively packaged and even readily mounted for point of purchase display, in such a manner that the card is inactive until activated at the point of purchase. The card may be activated at the point of purchase without the necessity of in any way opening up the attractive packaging, or moving any portion of the packaging out of the way, and by merely “swiping” the card while still mounted in the package through a conventional card reader. The card is mounted between first and second panels of primarily cellulose material including an area significantly greater than that of the card, with the card magnetic strip completely exposed (that is uncovered by the panels or any other packaging material). The majority of the card is typically sandwiched between the first and second panels and is removably held to the panels, for example by hold melt adhesive, and the panels are affixed to each other.

Baron et al., U.S. Pat. No. 5,809,481 describes a method and system for advertising that provides advertisers with a marketing database listing contact information for all potential consumers who received a promotional item from that advertiser and decided to retain the promotional item for future use. The promotional item is a tag bearing an advertisement, a contact identifier and a unique tag identifier. After receiving the tag from an advertiser, each recipient is instructed to attach the tag to a personal property item and to register the item with a processing facility that, with the use of an information storage and retrieval system, will create a master database comprising each recipient's contact information and tag identifier. The master database can be used to arrange for the return of a lost personal property item bearing a registered tag. The master database can also be sorted and contact information can be extracted therefrom to generate a marketing database for transmittal to advertisers.

Fajkowski, U.S. Pat. No. 5,905,246 describes a system for the electronic management and redemption of coupons. The system includes an integrated coupon card comprising a microprocessor, a random access memory, a scanner, and a communications port. The coupon card is capable of scanning coupon bar codes from paper coupons and receiving redemption requirement data from a periphery device. The coupon card will allow bar codes and redemption requirement data to be transferred to a periphery device and will store what bar codes were redeemed because they corresponded to purchase data received from a cash register memory. The system further includes one or more periphery devices having a microprocessor, a first communications port for communicating with said coupon card, and a second communications port for communicating with a cash register. The periphery devices receive purchase data from a cash register memory and compare purchase data to coupon bar codes received from a coupon card in order to determine which coupons are redeemable. The system also includes a server computer which will be connected to the periphery devices. The server computer will collect redeemed coupon information from the periphery devices and also provide the periphery devices with information such redemption requirement data or coupons which may be loaded onto a coupon card. A clearing house will collect coupon redemption information from all servers in the system to create redemption reports. The clearing house allows redemption requirement data and other information to be transferred through the servers to individual periphery devices and/or coupon cards.

Fiala, et al., U.S. Pat. No. 5,918,909 describes a method of activating a metered account that is associated with a personal identification number, where the personal identification number is affixed to a card and the metered account is activated at the time of sale of the card, and an apparatus comprising a package adapted for holding the card so that the method of the present invention can be practiced. The card includes an exposed data-encoded strip and the card preferably has a personal identification number thereon. The package includes a first panel and a retainer that secures the card to the first panel so that, when the card is secured to the panel, at least a portion of the data-encoded strip is exposed and laterally displaced remote from the panel. The data-encoded strip is encoded with a control number that is associated with the metered account. When the card is purchased, the control number is read from the data-encoded strip while the card is secured to the first panel, and the metered account is activated.

Christensen, U.S. Pat. No. 6,035,280 describes a method and apparatus for distributing, generating, and redeeming discount Virtual Coupons.TM., rebate or gift certificates or the like which may be used on conjunction with a frequency card program or the like. Virtual Coupons.TM. may be distributed electronically, for example, in the form of a diskette or CD-ROM software. Software on the diskette or CD-ROM may prompt a consumer to call a 1-800 number for a validation number or code. During the phone call, telemarketing personnel may request consumer demographic and or identification information which may be entered into a centralized database. Once the software is validated, a consumer may print out a list selected Virtual Coupons.TM. displayed on a Graphical User Interface (GUI). When a product is purchased, the UPC code of the product may be compared electronically with a list of Virtual Coupons.TM. authorized for a particular consumer. An appropriate coupon discount may then be applied and the Virtual Coupon.TM. may be considered “redeemed”. Once redeemed, consumer ID information and Virtual Coupon.TM. information may be retrieved electronically and used to update a central database. Accurate data may then be produced illustrating which consumers or groups of consumers are redeeming which Virtual Coupons.TM. Such data may be used for marketing purposes or to generated further diskettes for distribution targeting specific consumers or groups of consumers with specific classes of Virtual Coupon.TM. offerings. The use of Virtual Coupons.TM. eliminates or reduces fraud, and allows a frequency card discount to be applied only a limited number of times.

Fertig, U.S. Pat. No. 6,050,493 describes a pre-paid card for sending a gift such as flowers that is sized to fit inside a wallet, having a front face with photographs or drawings with a plurality of pre-selected gift items and back face with warranty and instructional information, as well as a telephone access number and a PIN number which is unique to the card. A plurality of pre-selected items depicted on the front face of the card will each have a corresponding identifier number or code, so that the card user can easily select a gift item to be ordered.

Bowie, U.S. Pat. No. 6,195,644 describes a method whereby credit card companies can program their computers to record and award Bonus Program Credits offered by airlines, hotels, rental car companies, etc. and relieve the latter of the burden of maintaining such records. This Abstract is not to be construed as a complete description of the invention or to limit the scope of the disclosure of the invention or of the claims.

Powell, U.S. Pat. No. 6,243,687 describes a system for dispensing and redeeming electronic discount coupons in a store. A card-dispensing kiosk collects information from a customer and subsequently issues a “smart card” for storing electronic coupons. Upon completion of shopping, the customer redeems the electronic coupons at the checkout area, by inserting the card into the checkout station. During checkout, when UPC product data corresponds to coupons stored on the card, the customer is credited with the value of the corresponding coupon.

The prior art teaches the use of coupons, paperless coupons, electronic coupons and such, but does not teach a method of use of paper coupons which need not be presented at the point of purchase. The present invention fulfills these needs and provides further related advantages as described in the following summary.

### SUMMARY OF THE INVENTION

The present invention teaches certain benefits in use which give rise to the objectives described below.

A commercial business method provides for establishing a relationship between a manager and plural consumers, manufacturers and retailers. The manager produces universal coupon wallet cards which are used instead of paper coupons but with the same effect as physical coupons of the type that may be received in the mails or cut from newspapers or magazines, etc. In this document we shall refer to the physical item carried by the consumer as a wallet card, because this is a popular item and is well known, however, it should be understood that the term wallet card shall also mean a keychain card or any other physical item that may be used in the manner, and for the effect defined herein. When a consumer, having one of the wallet cards sees a coupon which a special indicia printed on it identifying the coupon as able to be used without the actual presence of the coupon itself, the consumer is able to take note of the retailer, product and price and may then purchase the product as if using the physical coupon, by merely presenting the wallet card. The wallet card is scanned by the retailer so as to be able to forward information about the purchase is the corresponding manufacturer either directly or through the manager so as to establish a rebate to the retailer or to the consumer.

A primary objective of the present invention is to provide an apparatus and method of use of such apparatus that provides advantages not taught by the prior art.

Another objective is to provide such an invention capable of eliminating the need to cut coupons from a newspaper or magazine.

A further objective is to provide such an invention capable of providing rebates to retailers that give discounts to consumers.

A still further objective is to provide such an invention capable of collecting market preference and behavior information.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a flow diagram of the preferred embodiment of the invention;

FIG. 2 is a flow diagram of an alternate embodiment thereof; and

FIG. 3 is a flow diagram of still further alternate embodiment thereof.

### DETAILED DESCRIPTION OF THE INVENTION

The above described drawing figures illustrate the invention in at least one of its preferred embodiments, which is further defined in detail in the following description.

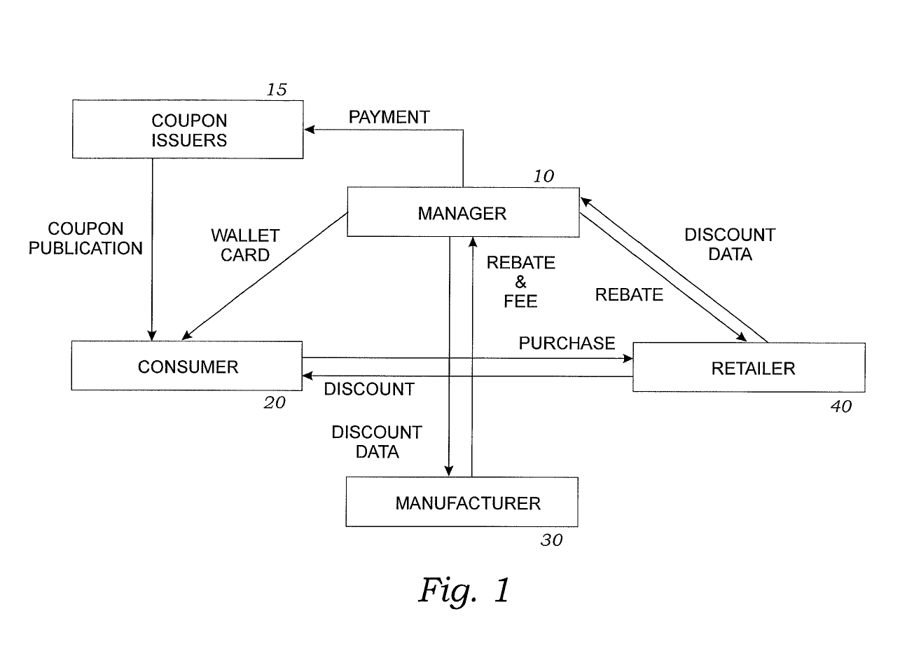

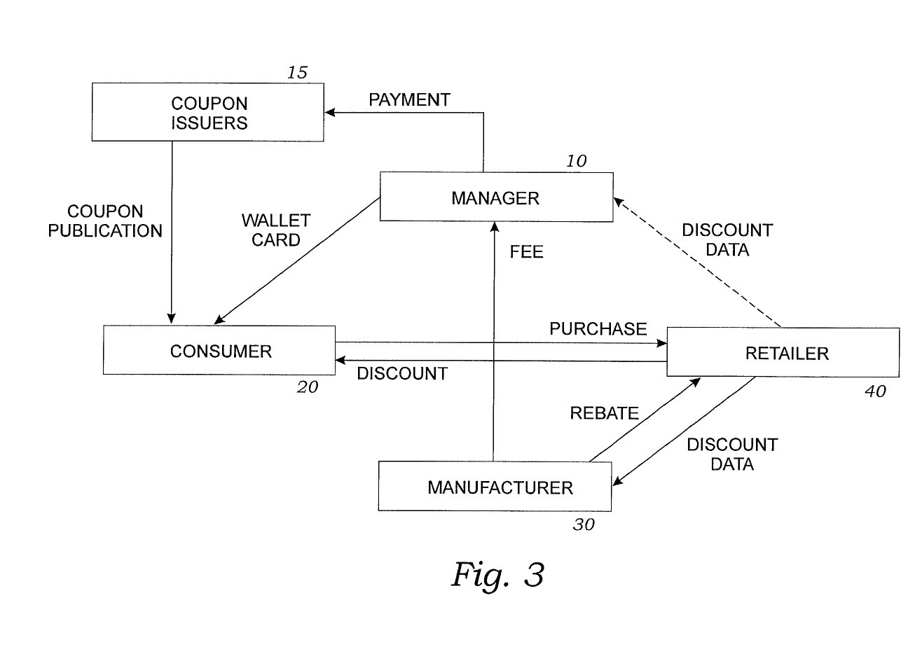

The present invention is a commercial business method. A manager 10 is defined as a business intermediary and functionally, may be a single or multiple businesses or persons. The manager 10 establishes a one to many relationship with each of: plural consumers 20, plural manufacturers 30 and plural retailers 40, as will be described in detail below. Each of the blocks 20, 30 and 40 in FIGS. 1-3, represent a large number of individual entities. In the case of consumers 20 the entity may be a natural person, a family or even a business. The sense here, is that the consumer entity is one who purchases good or services. In the case of the manufacturers 30, the entity is any who produces a good or service such as companies that manufacture or assemble goods or produce services, and this group also may represent distributors and wholesalers. The group of retailers 40, for purposes of this disclosure represents those selling retail or wholesale goods to the consumers 20 and so also may represent distributors and wholesalers. In the figures each of the blocks 20, 30 and 40 represents a plurality of entities, typically more than 100. The manager 10 produces a plurality of, what shall be called, a universal coupon wallet card. These cards provide, either on their faces, within the body of the card, or both, certain information. This information may, for instance, be contained in a magnetic stripe, printed bar code, imbedded circuitry with memory, etc. The information may include the card holder's identity, contact information, financial information, privilege level, and the like. The wallet cards are then distributed to the consumers, typically with one consumer receiving one card. The manager also alerts the manufacturers 30 and retailers 40 to the benefits of the method of this invention and enlists such manufacturers and retailers as wish to participate.

The manager provides for a special identification on publically placed coupons such as those that offer a purchase discount for selected products or services, or provide a special offer such as the well known two-for-one deal. This identification is a notification indicia, typically a graphical symbol or mark on the coupon and which is related to the wallet cards in that any coupon so marked is redeemable by using only the wallet card rather than the coupon itself. To accomplish this the manager 10 pays the coupon issuer 15, as shown in the figures. Such a fee may be minimal or it may be null. Potentially, those interested in having the widest response to their coupon issuance may offer payment to the manager to carry his/her indicia on their coupons. Of course, the coupons are generally published to the public by the coupon issuer, newspapers, magazines and so forth. The advantage of this approach is that the coupon need not be cut out or otherwise carried on the consumer's person, it need not be tendered to a clerk and it need not be handled after a purchase by the retailer. Upon the purchase of a product offered by a retailer, where the product may be redeemed by a related coupon, the wallet card is presented instead, the retailer provides the requisite discount to the consumer as if the consumer had presented the physical coupon. The purchase discount is provided to the consumer, for each of the selected products that any one of the consumers purchases at any one of the plural retailers, but only when they present one of the wallet cards. The wallet card is scanned or otherwise used to identify the purchaser. Many alternative methods of use exist. The following are variations:

1. The card carries only personal identification information and is used only as an identity card for purchses.

2. The card carries a value amount purchased by the consumer for later discounted purchases. This is similar to the well known phone card. This type of card may be refillable or just replaced when empty.

3. The card carries a fixed or variable discount level which is provided as a privilege for some consumer action. This is similar to an airline mileage card which provides benefits to the consumer for purchases or other actions and which are later redeemable.

4. The card may be a combination credit or debit card and also a discount coupon card and telephone time purchase card, etc. This is similar to the all purpose card that many have proposed but which is not available in the marketplace as yet.

The above examples show that the possibilities are almost limitless. The key inventive feature of the present invention is not the manner in which credit or privilege is assigned to, or used by, the wallet card, but rather that the wallet card is used as a vehicle to replace physical coupons. In that the wallet card can be merely a very thin and lightweight card easily carried by the consumer, it can provide significant advantage over the use of physical coupons such as less likely to be absent when the consumer approaches the cash register, no need to cut out and collect paper coupons, no need for the retailer to handle coupons of many sizes and types, including sorting and redeeming.

In FIG. 1 it is shown that the manager 10 dispenses the wallet cards to the consumers 20. The consumers then use the wallet cards to obtain purchase discounts. Since this is the consumer's motivation, the manufacturer is agreeable to offer a discount on his merchandise to outsell his competition. The retailer provides the discount data, a summary of discounts provided, to the manager and this information is broken down by the manager 10 and provided to the manufacturer 30. The manufacturer 30 is eager to receive this information because it provides important market activity feedback. The manufacturer 30 provides a rebate to the manager who passes it on to the retailer to compensate the retailer for the discount offered. In some instances the retailer is given less then the full discount in the rebate and this is acceptable for the increase in sales volume experiences. The manufacturer 30 also offers a service fee to the manager 10 in compensation for operating the system. Alternately, the manager 10 may derive compensation as the difference between rebate from manufacturer 30 and to retailer 40 when a positive differential exists. Preferably, the retailer 40 notifies the manager 10 of each of the purchase discounts issued via an electronic automated means such as the national consumer credit card system uses. In this embodiment, as is clear from the figure, all transactions between retailer 40 and manufacturer 30 move through the manager 10.

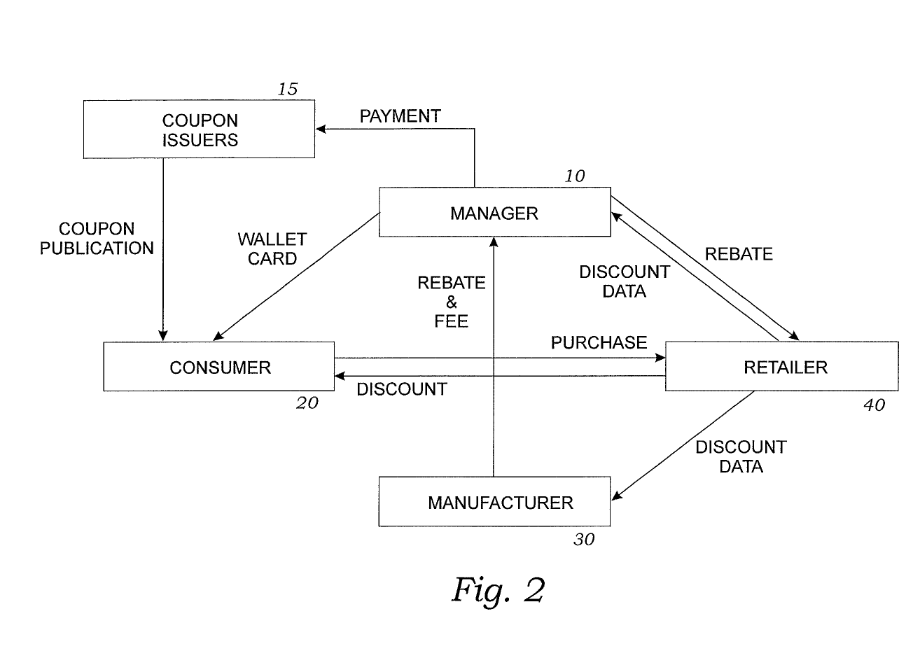

In an alternate embodiment of the present invention, shown in FIG. 2, the manufacturers 30 are directly notified by the retailers 40, of each of the purchase discounts issued by them. The manager 10 is issued a manufacturers rebate related to the purchase discounts tendered by the retailers 40 as well as a manager service fee. The manager 10 then pays the manufacturers rebate directly to the retailers 40.

In a still further embodiment of the present invention, the retailers 40 are paid a manufacturers rebate related to the purchase discounts tendered by them directly from the manufacturers 30, and the manager 10, is paid only a service fee.

It should be clear that in a large system with many hundreds of manufacturers and retailers, the preferred method is that shown in FIG. 1, where the manager 10 provides the critical function of coordination and proper directing of information, wallet cards, discount data, rebate payments, etc.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A commercial business method comprising the steps of: establishing a manager; establishing a one to many relationship between the manager and plural consumers; establishing a one to many relationship between the manager and plural manufacturers of consumer products; establishing a one to many relationship between the manager and plural retailers; producing a plurality of a universal coupon wallet cards; issuing one of the wallet cards to each of the plural consumers; identifying selected publically placed coupons, offering a purchase discount for a selected product, with a notification indicia related to the wallet cards; issuing the purchase discount for each of the selected products purchased at any one of the plural retailers by any one of the plural consumers upon presentation of one of the wallet cards; notifying the manager of each of the purchase discounts issued by the retailers; notifying the manufacturers of each of the purchase discounts identified to the manager; paying, to the manager, a manufacturers rebate related to the purchase discounts tendered by the retailers and a manager service fee; and paying, to the retailers, the manufacturers rebate.

2. A commercial business method comprising the steps of: establishing a manager; establishing a one to many relationship between the manager and plural consumers; establishing a one to many relationship between the manager and plural manufacturers of consumer products; establishing a one to many relationship between the manager and plural retailers; producing a plurality of a universal coupon wallet card; issuing one of the wallet cards to each of the plural consumers; identifying selected publically placed coupons, offering a purchase discount for a selected product, with a notification indicia related to the wallet cards; issuing the purchase discount for each of the selected products purchased at any one of the plural retailers by any one of the plural consumers upon presentation of one of the wallet cards; notifying the manufacturers of each of the purchase discounts issued by the retailers; paying, to the manager, a manufacturers rebate related to the purchase discounts tendered by the retailers and a manager service fee; and paying, to the retailers, the manufacturers rebate.

3. A commercial business method comprising the steps of: establishing a manager; establishing a one to many relationship between the manager and plural consumers; establishing a one to many relationship between the manager and plural manufacturers of consumer products; establishing a one to many relationship between the manager and plural retailers; producing a plurality of a universal coupon wallet card; issuing one of the wallet cards to each of the plural consumers; identifying selected publically placed coupons, offering a purchase discount for a selected product, with a notification indicia related to the wallet cards; issuing the purchase discount for each of the selected products purchased at any one of the plural retailers by any one of the plural consumers upon presentation of one of the wallet cards; notifying the manufacturers of each of the purchase discounts issued by the retailers; paying, to the retailers, a manufacturers rebate related to the purchase discounts tendered by the retailers; and paying, to the manager, a service fee.
